(19) United States
(12) Patent Application Publication
(10) Pub. No.: US 2005/0264542 A1
(43) Pub. Date: Dec. 1, 2005

(54) Stylus with function key

(75) Inventor: Wen-Hsiang Yueh, Hsinchuang City (TW)

Correspondence Address: APEX JURIS, PLLC, 13194 EDGEWATER LANE NORTHEAST, SEATTLE, WA, 98125, US

(73) Assignee: Partner Tech Corp, Taipei (TW)

(21) Appl. No.: 11/134,785

(22) Filed: May 20, 2005

(30) Foreign Application Priority Data
May 28, 2004 (TW) 93208495

(51) Int. Cl. G09G 5/00

(52) U.S. Cl. 345/179

(57) ABSTRACT

The present invention has a hollow stem, a printed circuit board, a cursor control unit, a control knob unit and a function key. The printed circuit board is located within the hollow stem, and the cursor control unit is located within the hollow stem and near a tip of the stylus. The control knob unit is positioned on the printed circuit board and has a turning knob protruding outwardly from the stem. The turning knob is rotatable and resilient so that data is input by rotation and pressure. The function key is positioned on the printed circuit board and protrudes outwardly from the stem. Thus, the present invention provides a stylus that is operable, convenient and ergonomic and integrated with function key to facilitate fast switching functions.

### BACKGROUND OF THE INVENTION

1. Field of the Invention

The present invention relates to a stylus with function key, and in particular to a stylus that is operable, convenient and ergonomic and integrated with a function key.

2. Description of Related Art

Because of fast and accurate cursor control, a mouse is a necessary input device and peripheral for a basic modern computer system.

One type of computer mouse, known as a mechanical mouse, includes a roller coated with a layer of rubber and protruding from the bottom of the mechanical mouse housing. Two shafts within the mechanical mouse are in contact with the roller, and two perforated wheels are respectively in contact with the two shafts. The two perforated wheels are perpendicularly positioned to detect translation along the X-axis and Y-axis. A light-emitting element is positioned near one side of the perforated wheel, and a light-receiving element is positioned near the other side of the perforated wheel. The light-emitting element is used to emit visible light or infrared light. When the mechanical mouse moves on a supporting surface, the roller rolls across the supporting surface. Thus, the perforated wheels are driven to rotate by the roller. When the light beam passes through the perforated wheels and is received by the light-receiving element, a pulse with a low level of voltage is generated. When the light beams are shielded by the perforated wheels, a pulse with a high level of voltage is generated. In this regards, when the mechanical mouse is in use, a series of pulses having high level of voltage or low level of voltage are generated. These pulses are transmitted to a central processing unit (CPU) and related electronic circuitry, which computes the translation and direction in which the mechanical mouse is moving.

Another type of mouse is called an optical mouse. Unlike the mechanical mouse, the optical mouse lacks a rolling-related mechanism. The optical mouse has two photo detectors perpendicularly positioned to detect translation along the X-axis and Y-axis. The optical mouse must move across a dedicated flat surface, and a dedicated flat surface has specifically patterned grid surface. When the photo detector emits a light beam on a smooth area of the dedicated flat surface, the light beam is reflected by the dedicated flat surface and an optical sensor detects the reflected light beam. Thus, a pulse with a low level of voltage is generated. When the photo detector emits a light beam onto gridlines of the dedicated flat surface, the light beam is absorbed by the gridlines. Thus, a pulse with a high level of voltage is generated. These pulses are then transmitted to a central processing unit (CPU) and related electronic circuitry, which translate the changes in detected luminance into translation and direction.

In the prior art, operation of the mechanical or optical mouse has not been drastically changed. Because of structures of the mechanical or optical mouse and compatibility of software, users would like to draw lines and write words at will.

Reference is made to FIG. 1. FIG. 1 illustrates a conventional stylus. The stylus includes a stem 90, and a printed circuit board (PCB) 91 is located within the stem 90. A roller-typed cursor control unit 92 is located within a tip of the stem 90. When a user grips the stem 90 of the stylus and makes the roller 93 roll, the user can use the stylus at will. Gripping the stylus is convenient. However, the stylus in the prior art does not include a function of fast-switching, so it is annoying to users.

### SUMMARY OF THE INVENTION

It is an object of the present invention to provide a stylus with a function key. According to the present invention, the stylus is operable, convenient, ergonomic and integrated with a function key to facilitate fast-switching functions.

In order to accomplish the object of the present invention, the present invention provides a stylus with function key. The present invention includes a hollow stem, a printed circuit board, a cursor control unit, a control knob unit and a function key. The printed circuit board is located within the hollow stem and has a radio transmitter, and the cursor control unit is located within the hollow stem and near a tip of the stylus. The control knob unit is positioned on the printed circuit board and has a turning knob protruding outwardly from the stem. The turning knob is rotatable and resilient, and data is input by rotating and pressing the turning knob. The function key is positioned on the printed circuit board and protrudes outwardly from the stem.

### BRIEF DESCRIPTION OF THE DRAWINGS

The present invention can be fully understood from the following detailed description and preferred embodiment with reference to the accompanying drawings, in which:

FIG. 1 is a partly perspective view of a conventional stylus;

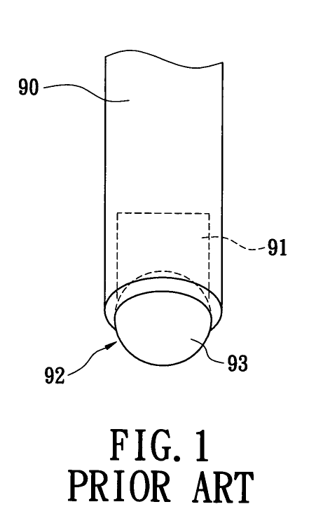

FIG. 2 is an exploded perspective view of one embodiment of the present invention;

FIG. 3 is a perspective view of one embodiment according to the present invention;

FIG. 4 is a cross-sectional view of one embodiment of FIG. 3; and

FIG. 5 is a cross-sectional view of another embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

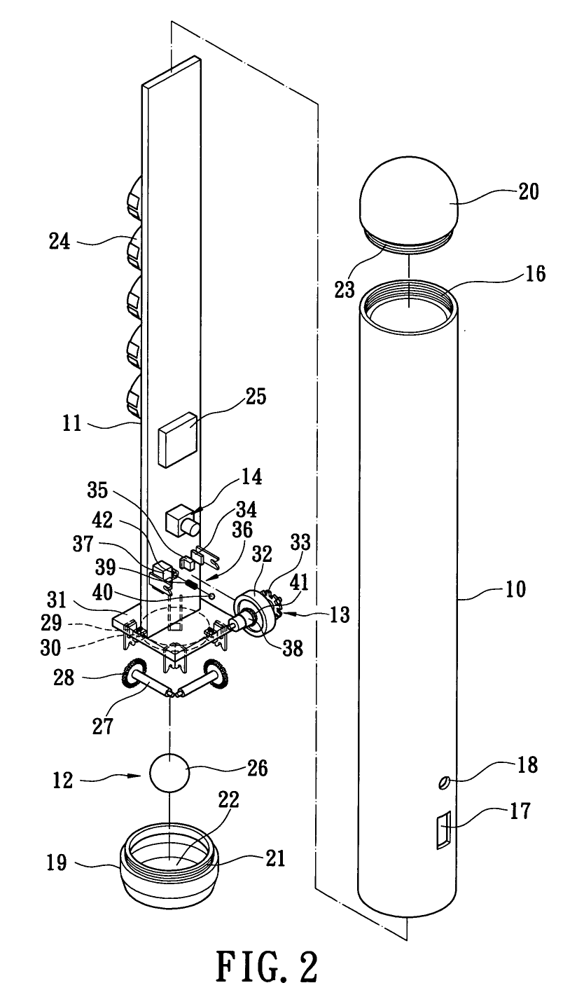

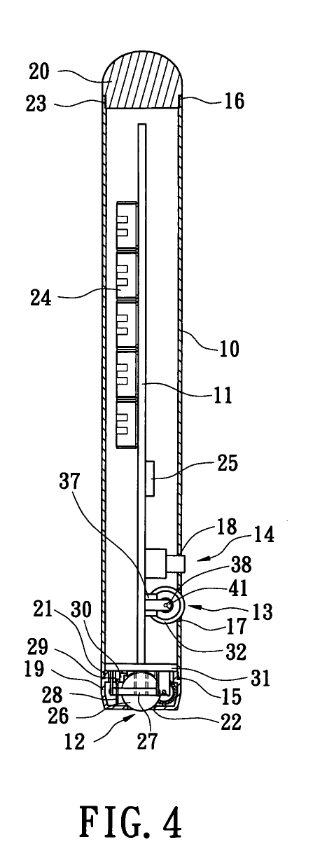

Reference is made to FIGS. 2-4. FIG. 2 is an exploded perspective view of one embodiment of the present invention. According to the present invention, a stylus includes a stem 10, a printed circuit board 11, a cursor control unit 12, at least one control knob unit 13, and at least one function key 14. The stem 10 is hollow and has circular cross-section. Both ends of the stem 10 are open and the inner surface thereof is integrally formed with a first thread 15 and a second thread 16. A slot 17 and a hole 18 are positioned near one end of the stem 10.

Both ends of the stem 10 are adapted to receive a taper-shaped cap 19 and a cone-shaped cap 20. A third thread 21 is provided on the outer surface at base of the taper-shaped cap 19. The first thread 15 meshes with the third thread 21 so that the taper-shaped cap 19 screws onto the end of the stem 10 via the thread 21. A through hole 22 is located in the taper-shaped cap 19 so that a roller 26 of the cursor control unit 12 is exposed thereby. A fourth thread 23 is provided on the outer surface of the cone-shaped cap 20 so that the cone-shaped cap 20 screws onto the end of the stem 10 via the fourth thread 23 and the second thread 16.

Reference is made to FIG. 2. As shown in FIG. 2, the printed circuit board 11 is rectangular and positioned within the stem 10. A plurality of electrical cells 24 are provided on the printed circuit board 11 to supply electrical power to the printed circuit board 11 and all electrical components thereof. A radio transmitter 25 is positioned on the printed circuit board 11 so that the radio transmitter 25 can transmit data via radio waves without connection cables. Thus, the present invention is integrated with the functions of a wireless mouse.

The cursor control unit 12 is located within and near one end of the stem 10. The cursor control unit 12 includes a rubber-coated roller 26, two shafts 27, two perforated wheels 28, two light-emitting elements 29 and two light-receiving elements 30. The roller 26 is located within the taper-shaped cap 19 so that part of the roller 26 is exposed. The two shafts 27 are pivotally connected to a positioning frame 31 positioned near one end of the printed circuit board 11. The two shafts are perpendicularly positioned and in contact with the rubber-coated roller 26. The two perforated wheels 28 are respectively secured at the two shafts 27, and the two light-emitting elements 29 and the two light-receiving elements 30 are located on the positioning frame 31. The light-emitting elements 29 are infrared light emitting diodes (LED), and the light-receiving elements 30 are photosensitive elements. In this regard, the two light-emitting elements 29 and the two light-receiving elements 30 are electrically connected to the printed circuit board 11 so that signals can be transmitted to the printed circuit board 11. The two perforated wheels 28 are positioned between the two light-emitting elements 29 and the two light-receiving elements 30. Specifically, the two light-emitting elements 29 are provided on one side of the two perforated wheels 28 and the two light-receiving elements 30 are provided on the other side of the two perforated wheels 28.

When a user grips the stem 10, the roller 26 rolls across a flat surface to drive the two shafts 27. Then, the two shafts 27 respectively drive the two perforated wheels 28. The two shafts 27 are perpendicularly positioned to detect translation in the X and Y directions. Each light-emitting element 29 is positioned near each perforated wheel 28, and is used to emit visible light or infrared light. When the light beam passes through the perforated wheels 28 and is received by the light-receiving element 30, a pulse with a low level of voltage is generated. When the light beams are shielded by the perforated wheels 28, a pulse with a high level of voltage is generated. Thus, when the perforated wheels 28 rotate, a series of pulses having a high level of voltage or a low level of voltage is generated. Then, these pulses are transmitted to a central processing unit (CPU) and related electronic circuitry, which translate the pulses into direction and translation.

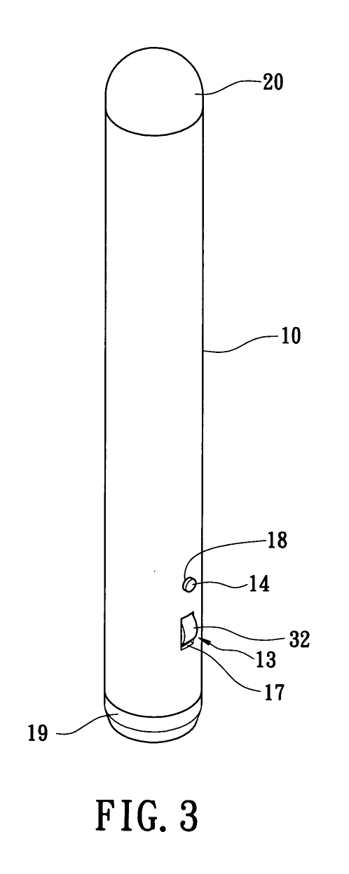

Reference is made to FIGS. 2 and 3. As shown in FIGS. 2 and 3, the present invention includes at least one control knob unit 13. The number of control knob units 13 can be increased if necessary. The control knob unit 13 includes a turning knob 32, a perforated wheel 33, a light-emitting element 34, a light-receiving element 35, a resilient unit 36 and a switching element 37. The turning knob 32 is axially connected to a shaft 38 and movably connected to the printed circuit board 11. The turning knob 32 of the control knob unit 13 is exposed and fits into the slot 17 of the stem 10, so that the turning knob 32 is conveniently turned and pressed downwardly.

Reference is further made to FIG. 2. As shown in FIG. 2, the perforated wheel 33 is axially connected to the shaft 38, and the light-emitting element 34 and the light-receiving element 35 are located on the printed circuit board 11. The light-emitting element 34 is an infrared light emitting diode (LED), and the light-receiving element 35 is a photosensitive element. In this regard, the light-emitting element 34 and the light-receiving element 35 are electrically connected to the printed circuit board 11 so that signals can be transmitted to the printed circuit board 11. The perforated wheel 33 is located between the light-emitting elements 34 and the light-receiving elements 35. Specifically, the light-emitting elements 34 are provided on one side of the perforated wheel 33 and the light-receiving element 35 is provided on the other side of the perforated wheel 33.

When user grips the stem 10, the turning knob 32 is driven to rotate the perforated wheel 33 via the shaft 38. The light-emitting element 34 is positioned on one side of the perforated wheel 33 and is used to emit visible light or infrared light. When the light beam passes through the perforated wheel 33 and is received by the light-receiving element 35, a pulse with a low level of voltage is generated. When the light beams is shielded by the perforated wheel 33, a pulse with a high level of voltage is generated. Thus, when the perforated wheel 33 rotates, a series of pulses having a high level of voltage or a low level of voltage are generated. Then, these pulses are transmitted to a central processing unit (CPU) and related electronic circuitry so that functions such as scroll up and down, flip pages, or delete are executed.

The resilient unit 36 includes a resilient element 39 and a positioning ball 40. The resilient element 39 is a tensile coil spring, and positioning teeth 41 are integrally and concentrically formed with the shaft 38. The resilient element 39 and the positioning ball 40 are adapted to be received by the positioning tube 42. The resilient element 39 is used to bias the positioning ball 40 to engage with the positioning teeth 41 of the shaft 38 and pushes the turning knob 32 upwardly to expose the same. When the turning knob 32 is turned, a ratcheting operation and associated sound are produced by friction between the positioning ball 40 and positioning teeth 41. The switching element 37 is provided at and electrically connected with the printed circuit board 11. The switching element 37 corresponds to the shaft 38, and the shaft 38 touches the switching element 38 when the turning knob 32 is pushed downwardly.

When user grips the stem 10 and pushes the turning knob 32 downwardly, the shaft 38 pushes the resilient element 39 so that the turning knob 32 and the shaft 38 are lowered. Thus, the shaft 38 is lowered to turn on the switching element 37, and these control signals are transmitted to the central processing unit (CPU) and related electronic circuitry to execute functions such as select or execute. According to the present invention, pushing the turning knob 32 of the control knob unit 13 is used to execute instructions of menu, navigate letters or drawings, or push buttons of a dialogue window.

The function key 14 is positioned on and electrically connected to the printed circuit board 11, and fits into the hole 18 of the stem 10. Thus, because the function key 14 is exposed, the function key 14 is convenient to push. The function key 14 can be configured by a user or built in by a manufacturer. For example, a language switching button is configured. It can be used to switch between the Chinese and the English language, or input method. The function key 14 can be configured to be a web-switching button or switching button between WORD and EXCEL. Functions of the function key 14 may also be integrated into the control knob unit 13. That is, the control knob unit 13 may be used as the function key 14.

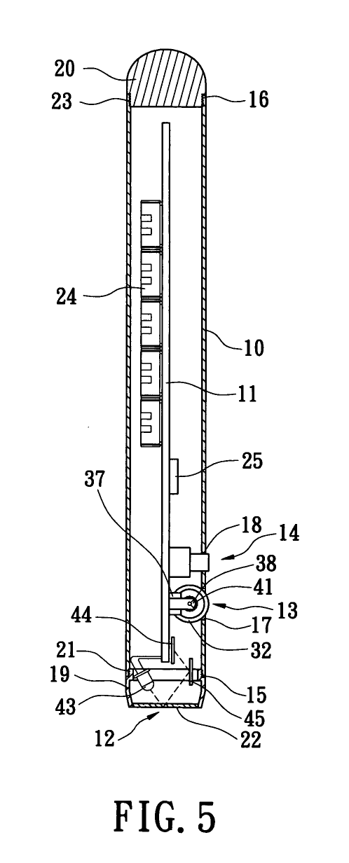

Reference is made to FIG. 5. As shown in FIG. 5, the cursor control unit 12 includes a photo detction device. The photo detection device includes a light-emitting element 43 and a light-receiving element 44. A reflective mirror is located between the light-emitting element 43 and a light-receiving element 44. The cursor control unit 12 must move across a dedicated flat surface, and the dedicated flat surface is a specifically patterned grid surface. When the light-emitting element 43 emits a light beam onto a smooth area of the dedicated flat surface, the light beam is reflected by the dedicated flat surface and the light-receiving element 44 detects the reflected light beam. Thus, a pulse with a low level of voltage is generated. When the light-emitting element 43 emits a light beam onto gridlines of the dedicated flat surface, the light beam is absorbed by the gridlines. Thus, a pulse with a high level of voltage is generated. In this regard, these pulses are transmitted to a central processing unit (CPU) and related electronic circuitry, which translate the changes in detected luminance into direction and displacement information.

As described above, the present invention provides a stylus that is operable, convenient and ergonomic and integrated with function key 14 to facilitate fast switching functions.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

1. A stylus with function key, comprising:
a hollow stem;
a printed circuit board, positioned within the hollow stem and having a radio transmitter;
a cursor control-unit, positioned within the hollow stem and near a tip of the stylus;
a control knob unit, positioned on the printed circuit board and having a turning knob protruding outwardly from the stem, whereby data is input by rotating and pressing the turning knob; and
a function key, positioned on the printed circuit board and protruding outwardly from the stem.

2. The stylus with function key as claimed in claim 1, wherein a through hole is located in a taper-shaped cap to expose the cursor control unit.

3. The stylus with function key as claimed in claim 1, wherein a cone-shaped cap screws onto an end of the stem.

4. The stylus with function key as claimed in claim 1, wherein a slot is located in the stem and the control knob unit fits into the slot.

5. The stylus with function key as claimed in claim 1, wherein a plurality of electrical cells are provided on the printed circuit board to supply electrical power to the printed circuit board and all electrical components thereof.

6. The stylus with function key as claimed in claim 1, wherein the cursor control unit includes a roller, two shafts, two perforated wheels, two light-emitting elements, and two light-receiving elements, and the roller is located within the stem to expose part of the roller, and the two shafts are pivotally connected to a positioning frame positioned near one end of the printed circuit board, the two shafts are perpendicularly positioned and are in contact with the roller, the two perforated wheels are respectively secured on the two shafts, the two light-emitting elements and the two light-receiving elements are located on the positioning frame, and the two perforated wheels are located between the two light-emitting elements and the two light-receiving elements.

7. The stylus with function key as claimed in claim 1, wherein the cursor control unit includes a light-emitting element and a light-receiving element, and when a light beam emitted by the light-emitting element is reflected by a reflective mirror, the light-receiving element detects the reflected light beam.

8. The stylus with function key as claimed in claim 1, wherein the control knob unit includes a turning knob, a perforated wheel, a light-emitting element, a light-receiving element and a switching element, wherein the turning knob is axially connected to a shaft and movably connected to the printed circuit board, and wherein the light-emitting element, the light-receiving element, and the switching element are located on the printed circuit board, the perforated wheel is located between the light-emitting element and the light-receiving element, and the switching element corresponds to the shaft.

9. The stylus with function key as claimed in claim 8, wherein the turning knob includes a resilient unit having a resilient element and positioning teeth integrally and concentrically formed with the shaft, the resilient element and the positioning ball are adapted to be received in the positioning tube and the resilient element is used to bias the positioning ball to engage with the positioning teeth.

10. The stylus with function key as claimed in claim 1, wherein functions of the function key are integrated into the control knob unit.

11. The stylus with function key as claimed in claim 1, wherein the function key is configured to switch between Chinese and English languages or input methods, to function as a web-switching button, or switch between WORD and EXCEL.
